(19) United States
(12) Patent Application Publication
(10) Pub. No.: US 2008/0082914 A1
(43) Pub. Date: Apr. 3, 2008

(54) DOCUMENT DATA EDIT DEVICE, DOCUMENTATION SYSTEM, AND COMPUTER PROGRAM PRODUCT

(75) Inventors: Hideo UENO, Nagoya-shi (JP); Masashi SUZUKI, Nagoya-shi (JP); Hiroshi KOIE, Nagoya-shi (JP); Kazunari TAKI, Nagoya-shi (JP); Takahiro IKENO, Seto-shi (JP); Takahiro HOSOKAWA, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/860,259

(22) Filed: Sep. 24, 2007

(30) Foreign Application Priority Data
Sep. 29, 2006 (JP) 2006-266910

(51) Int. Cl. G06F 15/04

(52) U.S. Cl. 715/273

(57) ABSTRACT

A document data edit device includes an input unit that inputs data in input modes including at least two of a first input mode, a second input mode and a third input mode. Data inputted in the first input mode is formed as an image on a recording medium, data inputted in the second input mode is recorded as data on a non-contact tag attached to the recording medium, and data inputted in the third input mode is formed as an image on the recording medium and recorded as data on the non-contact tag.

### CROSS-REFERENCE TO RELATED APPLICATION

This application claims priority from Japanese Patent Application No. 2006-266910, filed on Sep. 29, 2006, the entire subject matter of which is incorporated herein by reference.

### TECHNICAL FIELD

Aspects of the present invention relate to a document data edit device which can generate or set document data to be formed as an image on a recording medium and document data to be recorded as data on a non-contact tag and to a documentation system which utilizes the document data edit device and to a computer program product for operating the document data edit device.

### BACKGROUND

A non-contact tag such as a Radio Frequency Identification tag (RFID tag) is attached to (or also imbedded in) a recording medium such as a sheet. An image formed on such a recording medium and at the same time, data is recorded on the non-contact tag. For example, JP-A-2005-212303 describes that when data to be recorded on the non-contact tag is received, the data is formed as an image on the sheet as well as recorded as data on the non-contact tag attached to the sheet. In addition, an image based on data prepared in advance is also formed on the recording medium along with the image based on the received data.

### SUMMARY

However, conventionally, it is necessary to separately generate data to be formed as an image on the recording medium, data to be recorded as data on the non-contact tag, and data to be formed as an image on the recording medium as well as to be recorded as data on the non-contact tag, with bad edit efficiency.

Aspects of the present invention relate to the above-problem. According to at least one aspect of the invention, a document data edit device may be provided that efficiently generates or sets data to be formed as an image on a recording medium, data to be recorded as data on a non-contact tag, and data to be formed as an image on the recording medium as well as to be recorded as data on the non-contact tag.

According to an aspect of the present invention, a document data edit device includes: an input unit that inputs data in input modes including at least two of a first input mode, a second input mode and a third input mode. Data inputted in the first input mode is formed as an image on a recording medium, data inputted in the second input mode is recorded as data on a non-contact tag attached to the recording medium, and data inputted in the third input mode is formed as an image on the recording medium and recorded as data on the non-contact tag.

### BRIEF DESCRIPTION OF THE DRAWINGS

In the accompanying drawings:

FIG. 1 is a block diagram showing the configuration of a documentation system according to an embodiment of the present invention;

FIG. 2 is a schematic cross-sectional view showing the internal configuration of a printer included in the documentation system;

FIG. 3 is an explanatory view showing an example of the configuration of a sheet equipped with a non-contact tag;

FIG. 4 is a flowchart showing a printing control process to be executed in a PC included in the documentation system;

FIG. 5 is a flowchart showing a document input and edit process in the printing control process;

FIGS. 6A to 6C are explanatory views showing an exemplary input in the document input and edit process;

FIGS. 7A to 7C is explanatory views showing another exemplary input in the document input and edit process;

FIG. 8 is a flowchart showing a tag writing and printing modification process in the printing control process;

FIG. 9A to 9C are explanatory views showing an exemplary input in the tag writing and printing modification process;

FIG. 10 is a flowchart showing a modification process in the printing control process;

FIGS. 11A and 11B are explanatory views showing an exemplary input in the modification process;

FIG. 12 is a flowchart showing a printing process in the printing control process;

FIG. 13 is a flowchart showing a printer printing process to be executed in the printer;

FIG. 14 is a flowchart showing a tag data read process to be executed in the printer;

FIG. 15 is a flowchart showing a modified example of the printer printing process;

FIG. 16 is an explanatory schematic view showing the configuration of a label printer according to an embodiment of the present invention;

FIGS. 17A to 17C is an explanatory view showing an exemplary input when the label printer is used; and

FIG. 18 is a flowchart showing a modified example of the tag data read process.

### DETAILED DESCRIPTION

[Overall Configuration of the Embodiment]

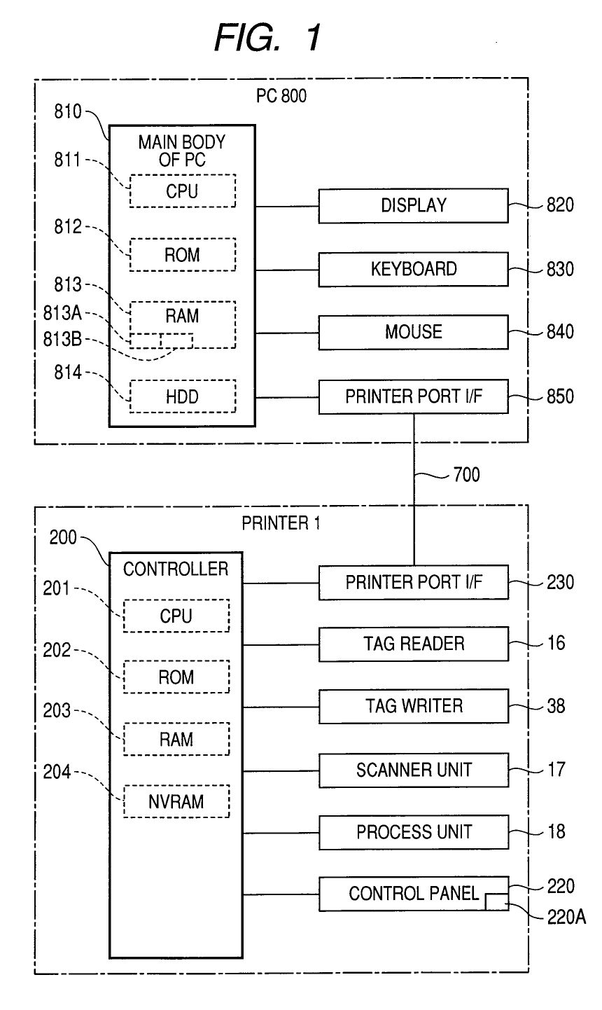

Next, embodiments of the present invention will be described below with reference to the accompanying drawings. FIG. 1 is a block diagram showing the configuration of a documentation system according to an embodiment of the present invention. As shown in FIG. 1, the documentation system of this embodiment includes a printer 1 serving as an image forming apparatus and a personal computer (hereinafter simply referred to as PC□ 800 serving as a document data edit device connected to the printer 1 via a cable 700. Note that the printer 1 and PC 800 are connected via an intranet LAN or the Internet.

[Description of the Configuration of the Printer 1]

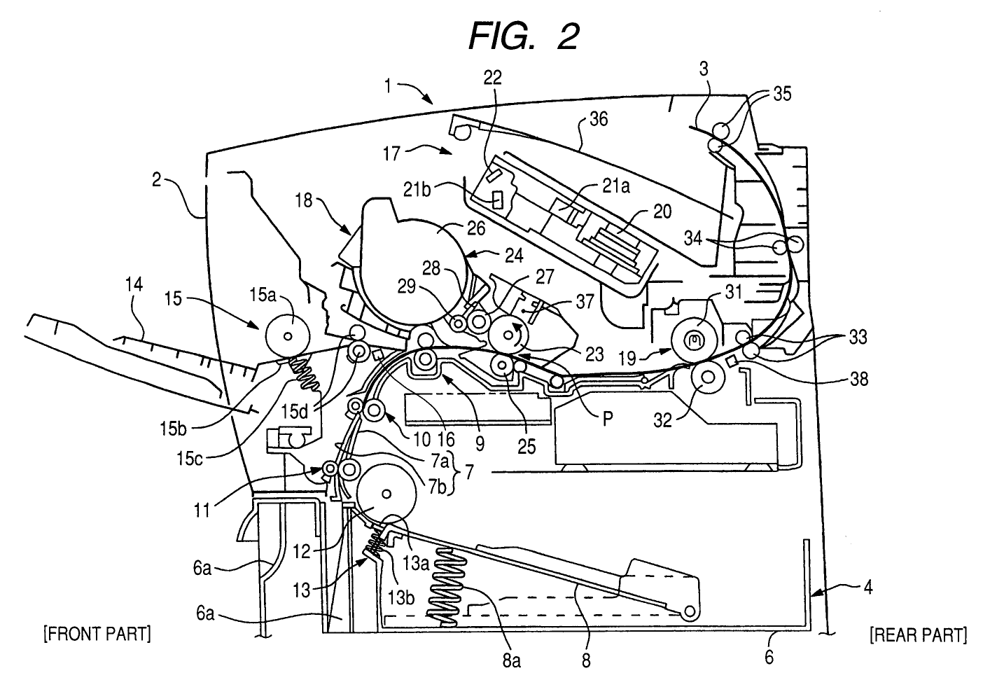

FIG. 2 is a schematic cross-sectional view showing the internal configuration of the printer 1. As shown in FIG. 2, within a main body case 2, the printer 1 includes a feeder part 4 for feeding sheet 3 serving as a recording medium; a multi-purpose tray 14; a process unit 18 as an example of an image forming unit for forming an image on the fed sheet 3; and a fixing unit 19. Note that in the printer 1, the side on which the multi-purpose tray 14 is mounted in the main body case 2 (the left side in FIG. 2) is hereinafter referred to as the “front part,” while the side opposite on which the multi-purpose tray 14 is mounted in the main body case 2 is referred to as the “rear part.”

[Description of the Configuration of the Feeder Part 4]

As shown in FIG. 2, in the bottom part of the main body case 2, the feeder part 4 includes a detachable sheet feed tray 6, a sheet retainer plate 8 provided in the sheet feed tray 6, a feed roller 12 provided above an end of the sheet feed tray 6, and a separation pad 13. In addition, there is provided a curved feed path 7 from the feed roller 12 to an image forming position P (or a contact part between a photosensitive drum 23 and a transfer roller 25, i.e., a transfer position at which a toner image on the photosensitive drum 23 is transferred onto the sheet 3).

The sheet retainer plate 8, which can retain the sheets 3 stacked in layers, is pivotably supported at the distal end part relative to the feed roller 12, thereby the proximal end part is allowed to move up and down. The sheet retainer plate 8 is upwardly energized by a spring 8a on its back. The separation pad 13 is disposed to oppose the feed roller 12, so that a pad 13a composed of a member having a high friction coefficient is pushed against the feed roller 12 by a spring 13b.

On the other hand, the feed path 7 is formed in a curved shape by a pair of guide plates 7a and 7b for guiding the sheet 3. In addition, there are disposed at appropriate intervals on the feed path 7 sequentially from the upstream of the sheet feed direction, the feed roller 12; a pair of feed rollers 11 including a pair of a drive roller and a follower roller; a pair of feed rollers 10 including a pair of a drive roller and a follower roller; and a pair of registration rollers 9 including a pair of a drive roller and a follower roller disposed immediately before the image forming position P.

In the feeder part 4 configured as described above, the topmost sheet 3 of those stacked in layers on the sheet retainer plate 8 is pushed against the feed roller 12, and sandwiched between the feed roller 12 and the separation pad 13 by the feed roller 12 being rotated, thereby sheets are fed one by one. The thus fed sheet 3 is also fed by the feed rollers 11, and then sequentially by the feed rollers 10 and the registration rollers 9 to the image forming position P with a predetermined timing.

[Description of the Configuration of the Multi-Purpose Tray 14]

On the front part side of the main body case 2 above the feeder part 4, there are disposed the multi-purpose tray 14 which serves to supply the sheets 3 manually or automatically and a multi-purpose side sheet feed mechanism 15 for feeding the sheets 3 stacked in layers on the multi-purpose tray 14. The multi-purpose side sheet feed mechanism 15 includes a feed roller for the multi-purpose tray 15a and a multi-purpose side sheet feed pad 15b, and allows the multi-purpose side sheet feed pad 15b to be pushed against the feed roller for the multi-purpose tray 15a by a spring 15c disposed on the back of the multi-purpose side sheet feed pad 15b. In addition, the multi-purpose side sheet feed mechanism 15 includes a pair of feed rollers 15d including a pair of drive roller and a follower roller.

In the multi-purpose tray 14 configured as described above, the sheets 3 stacked in layers on the multi-purpose tray 14 are sandwiched between the feed roller for the multi-purpose tray 15a being rotated and the multi-purpose side sheet feed pad 15b, and then fed one by one to the registration rollers 9 via a pair of feed rollers 15d.

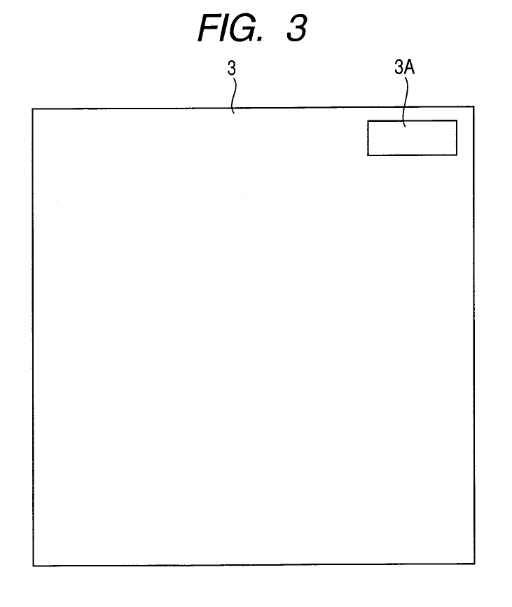

There is also disposed a tag reader 16 serving as data reading unit between the feed rollers 15d, 10 and the registration rollers 9. When the sheet 3 as shown in FIG. 3 having a Radio Frequency Identification Tag (RFID tag: hereinafter simply referred to as the tag) 3A as an example of a non-contact tag is used, the tag reader 16 reads data recorded on the tag 3A. Consequently, while the sheet 3 equipped with the tag 3A is transported from the sheet feed tray 6 or the multi-purpose tray 14 to the image forming position P, the tag reader 16 can read data from the tag 3A attached to the sheet 3. Note that when data is read from (read out from) the tag 3A attached to the sheet 3 held in the multi-purpose tray 14, it is not always necessary to read (read out) the data by the tag reader 16 while the sheet 3 is being fed. For example, with the sheet 3 being held (placed) in the multi-purpose tray 14, the data may be read (read out) from the tag 3A attached to the sheet 3 by the tag reader 16.

[Description of the Configuration of a Scanner Unit 17]

The scanner unit 17 is disposed under a sheet discharging tray 36 in the upper part of the main body case 2, and includes a laser emitting part (not shown), a rotatably driven polygon mirror 20, lenses 21a and 21b, and a reflection mirror 22. The laser emitting part emits a laser beam and the laser beam is passing through or reflected from the polygon mirror 20, the lens 21a, the reflection mirror 22, and the lens 21b so that the scanner unit 17 allows a laser beam to illuminate and quickly scan across the surface of the photosensitive drum 23 of the process unit 18.

[Description of the Configuration of the Process Unit 18]

The process unit 18 includes the photosensitive drum 23 serving as an electrostatic latent image carrier, a scorotron type electrifier 37, a drum cartridge having the transfer roller 25 or the like, and a developing cartridge 24 detachably attached to the drum cartridge. The developing cartridge 24 includes a toner accommodating part 26, a developing roller 27, a layer thickness restricting blade 28, and a toner supply roller 29.

The toner accommodating part 26 is filled with positively charged non-magnetic one-composition polymeric toner as a developer. The toner is supplied by the toner supply roller 29 to the developing roller 27, at the time of which the toner is positively charged by friction between the toner supply roller 29 and the developing roller 27. Furthermore, the toner supplied onto the developing roller 27 is carried on the developing roller 27 in a thin layer of a uniform thickness by the layer thickness restricting blade 28 as the developing roller 27 rotates. On the other hand, the rotating photosensitive drum 23 is disposed opposite the developing roller 27, with the drum body being grounded and its surface being formed of a positively charged organic photosensitive material.

The scorotron type electrifier 37 is disposed above the photosensitive drum 23 with a predetermined gap therebetween so as not to be in contact with the photosensitive drum 23. The scorotron type electrifier 37 is a positively charging scorotron type electrifier which generates corona discharge from an electrifying wire such as of tungsten, and is designed to positively electrify the surface of the photosensitive drum 23 uniformly.

Then, as the photosensitive drum 23 rotates, the surface of the photosensitive drum 23 is first uniformly and positively charged by the scorotron type electrifier 37, and thereafter exposed to the laser beam from the scanner unit 17 during a quick scan, thereby an electrostatic latent image is formed based on the image data.

Subsequently, as the developing roller 27 rotates, the positively charged toner carried on the developing roller 27 is brought into contact with the photosensitive drum 23. At this time, the toner is supplied onto the electrostatic latent image formed on the surface of the photosensitive drum 23, i.e., onto the exposed part having a reduced potential due to the exposure to the laser beam on the uniformly and positively charged surface of the photosensitive drum 23. Thus, the toner is selectively carried to visualize the image, thereby a toner image is formed.

The transfer roller 25 is disposed below the photosensitive drum 23 to oppose the photosensitive drum 23, and supported rotatably in the clockwise direction in FIG. 2 in the drum cartridge. The transfer roller 25 is configured such that a metal roller shaft is coated with a roller formed of an ionic conductive rubber material, and receives a transfer bias (forward transfer bias) applied thereto from a transfer bias application power supply during transfer. Consequently, the toner image carried on the surface of the photosensitive drum 23 is transferred onto the sheet 3 at the above-described image forming position P while the sheet 3 is passing through between the photosensitive drum 23 and the transfer roller 25.

[Description of the Configuration of the Fixing Unit 19]

As shown in FIG. 2, the fixing unit 19 is disposed to the right of the process unit 18 downstream of the feed direction, and includes one heating roller 31, a pressure roller 32 disposed to push against the heating roller 31, and a pair of feed rollers 33 provided downstream of them. The heating roller 31, which is formed of a metal such as aluminum and includes a heater such as a halogen lamp for heating, allows the toner transferred to the sheet 3 in the process unit 18 to be thermally fixed while the sheet 3 passes through between the heating roller 31 and the pressure roller 32. Thereafter, the sheet 3 is fed by the feed rollers 33 into the discharging path in the rear side part of the main body case 2, and then further fed by feed rollers 34 and discharge rollers 35. Subsequently, the sheet 3 is discharged onto the sheet discharging tray 36.

Furthermore, there is provided a tag writer 38, as an example of data recording unit capable of recording data on the above-described tag 3A, on the sheet feed path between the heating roller 31, the pressure roller 32, and the feed rollers 33. Consequently, when the sheet 3 equipped with the tag 3A is used, desired data can be recorded on (or also written to) the tag 3A of the sheet 3 after an image has been formed thereon.

[Description of the Control System of the Printer 1]

In addition, on the upper surface of the printer 1, there are provided various types of buttons (not shown) such as a tag reading button 220A or an operation panel 220 (see FIG. 1) with a liquid crystal display. Referring back to FIG. 1, the operation panel 220 is connected to a controller 200 in conjunction with the process unit 18, the scanner unit 17, the tag writer 38, and the tag reader 16. The controller 200 is configured as a microcomputer including a CPU 201, a ROM 202, a RAM 203, and a NVRAM 204 in which stored contents will not be erased even when the power supply switch is turned OFF. In addition, the controller 200 is connected to the PC 800 via a printer port interface (printer port I/F) 230 and the network 700.

A PC main body 810 of a PC 800 mainly consists of a CPU 811, a ROM 812, a RAM 813, and a hard disk drive (HDD) 814. Here, the RAM 813 includes a tag write data area 813A and a print data area 813B, to be discussed later. Additionally, the PC main body 810 is connected with a display 820 such as a CRT, a key board 830, a mouse 840, a printer port interface (printer port 1/F) 850 for connecting to a controller 200 of a printer 1 and the like.

[Processing at the Control System (Processing at the PC 800)]

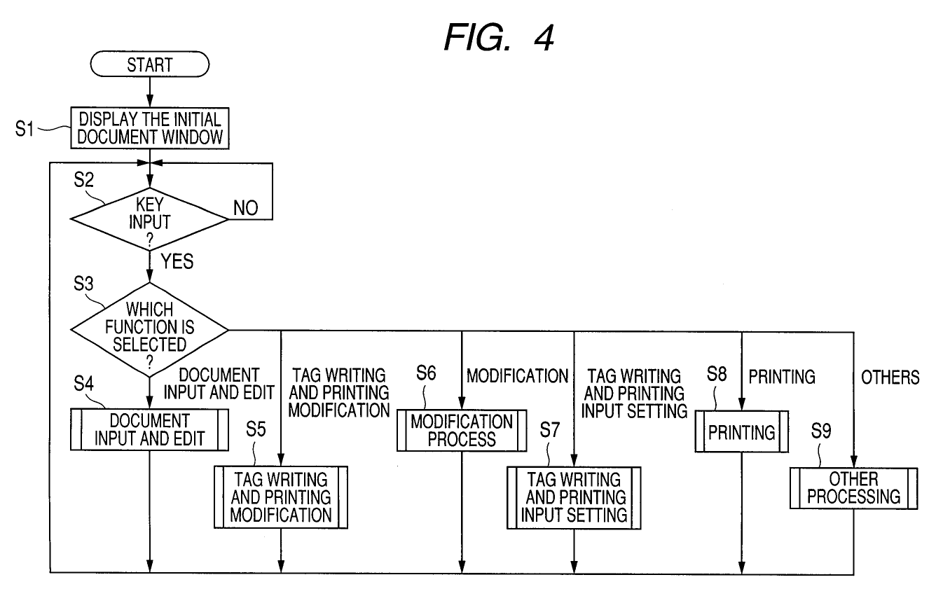

Now, a description will be made for this control system. FIG. 4 is a flowchart showing a printing control process to be executed at the PC 800. Note that this processing is started by the CPU 811 executing a predetermined program stored in the HDD 814 when an instruction to perform this process is issued on the PC 800.

As shown in FIG. 4, when the process is started, first in S1 (hereinafter S stands for a step), an initial window on which documents are edited is displayed on the display 820. In S2, it is determined whether user's key input is performed. The process waits in S2 until a key is pressed (S2: N). If a key is pressed (S2: Y), then the process proceeds to S3 to determine a selected function. Then, in response to the selected function, the process executes any one of a document input and edit (S4), a tag writing and printing modification process (S5), a modification process (S6), tag writing and printing input setting (S7), printing (S8), and other processes (S9). Then, the process proceeds to S2 mentioned above.

Here, for example, the other processes in S9 include various processes such as reading and pasting of existing document data. Furthermore, the tag writing and printing input setting of S7 is to set a document input mode to be subsequently performed. This document input mode includes inputting a document only for printing on a sheet 3 (hereinafter referred to as the printing mode or first input mode), inputting a document only for writing as data on a tag 3A (hereinafter referred to as the tag write mode or second input mode), inputting a document for both of them (hereinafter referred to as the tag write and printing mode or third input mode), or inputting documents separately while data to be printed onto the sheet 3 and data to be written onto the tag 3A are associated with each other (hereinafter referred to as the tag write and printing separate data mode). Note that in the tag writing and printing input setting of S7, the printing mode is set as a default mode. The other processes will be described in more detail below.

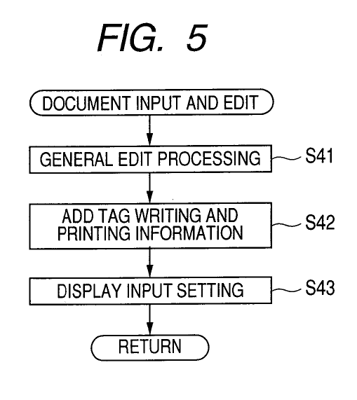

FIG. 5 is a flowchart showing in detail the document input and edit process of S4. As shown in FIG. 5, in this process, first in S41, a typical edit process is performed in response to an input on the key board 830 or the like. In S42, information of tag writing and printing set in S7 or provided as default information, i.e., information indicating the input mode is added to the document data input in S41. In S43, based on the input mode, the input document data is displayed on the display 820, and the process proceeds to S2 mentioned above. Note that the display format in S43 can be optionally set to various ones, e.g., a normal display format in the printing mode and a special display format such as reverse, flashing, differently colored characters, or hatching format in the other input modes. In particular, in the tag write and printing separate data mode, document to be written onto the tag 3A and the document to be printed are alternately displayed. Note that a character inputted in the printing mode can also be displayed in a special display format, optionally.

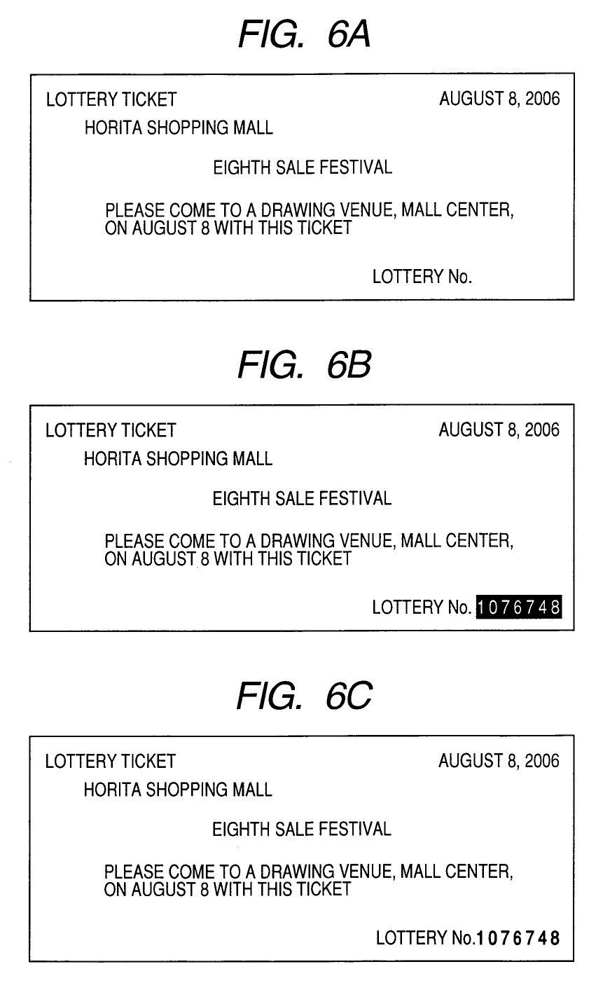

For example, as shown in FIG. 6A, suppose that the contents of a lottery ticket are generated in the printing mode (S41), and then a lottery number is written thereon in the tag write and printing mode (S42). At this time, as shown in FIG. 6B as an example, only the lottery number is reversed for display (S43). In this case, an image as shown in FIG. 6C as an example is generated as data for printing, thereby allowing the lottery number “1076748” to be printed as well as written onto the tag 3A (S42). This makes it possible to quickly announce the drawing result with ease by reading the data from the tag 3A and comparing it with the winning number.

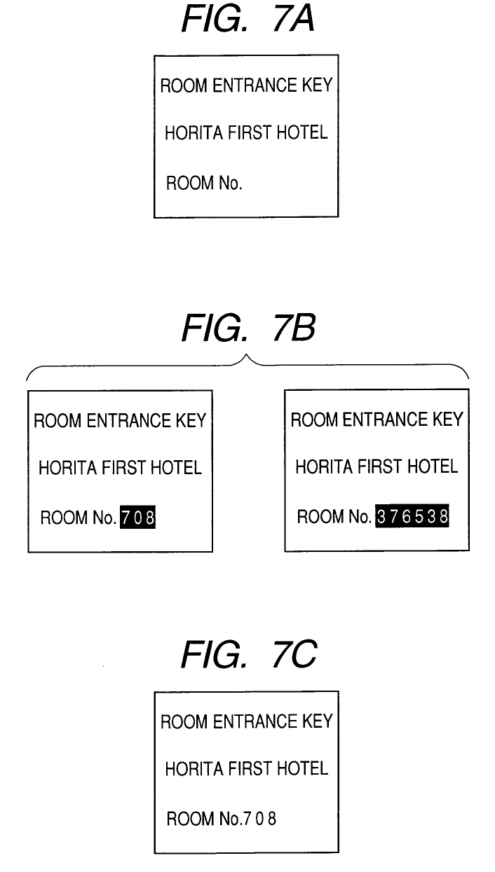

As shown in FIG. 7A as an example, suppose also that the contents for a room entrance key of a hotel are generated in the printing mode (S41), and then a room number and a code for unlocking the room are inputted in the tag write and printing separate data mode (S41). Then, as shown in FIG. 7B as an example, the room number and the code are alternately flashed for display (S43). In this case, an image shown in FIG. 7C as an example is generated as data for printing (S42), the room number “708” is printed, but the code “376538” is not printed, with only “376538” stored on the tag 3A (S42). Accordingly, the code “376538” is not known to the guest, thereby preventing the entry key from being forged.

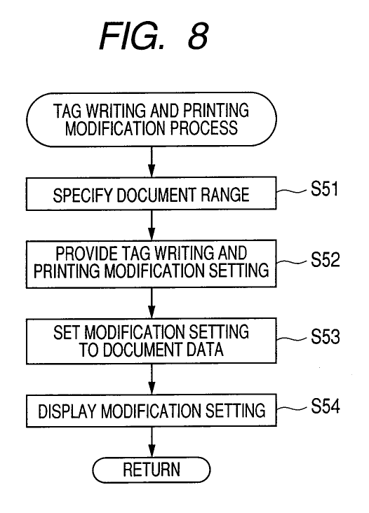

FIG. 8 is a flowchart showing in detail the tag writing and printing modification process of S5. In this process, first in S51, in response to an input on the key board 830 or with the mouse 840, a range is specified in the document already displayed on the display 820. Note that this range may be specified in various ways, e.g., character by character, string by string, or row by row.

In S52, in response to an input on the key board 830 or with the mouse 840, a tag writing and printing modification, i.e., one of the input modes mentioned above is set to the specified range. In S53 and S54, information indicating the modification setting or the input mode is added to document data as in S42 and S43 (S53). Based on the input mode, the indication on the display 820 is changed (S54), and then the process proceeds to S2 mentioned above.

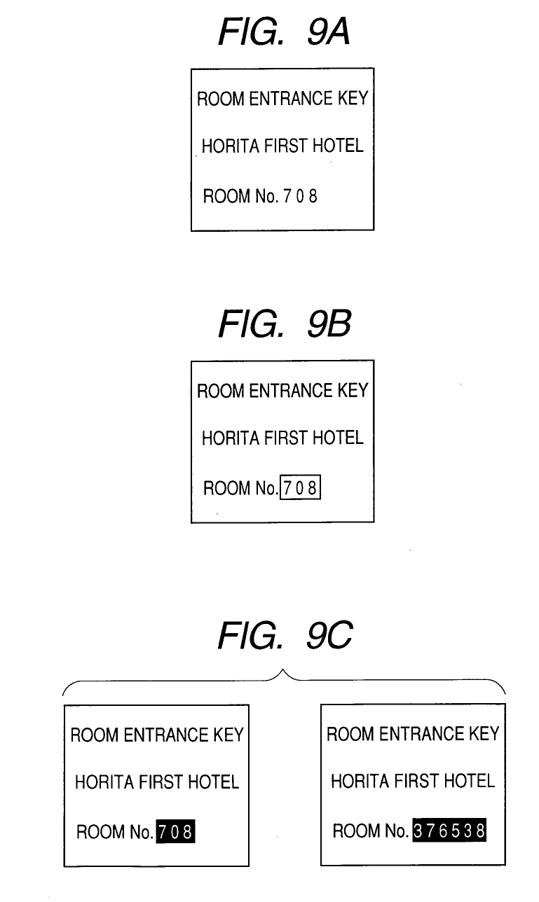

Accordingly, for example, as shown in FIG. 9A as an example, the entire contents to be printed for the hotel key are inputted in the printing mode (S5), then as shown in FIG. 9B as an example, the range of the room number “708” is specified (S51), the tag write and printing separate data mode is set (S53), and the code “376538” is inputted. This causes the indication on the display 820 to be changed as shown in FIG. 9C (S54). That is, as shown in FIG. 7B above, the room number and the code are alternately flashed for display.

Note that in each of the specific examples (FIGS. 6A to 6C, FIGS. 7A to 7C, and FIGS. 9A to 9C), description was made in such a case where a main input is made in the printing mode. However, when a main input is made in another input mode such as the tag write mode, the input mode can be changed as described above (S7) or the range specifying can be made (S51), thereby allowing the printing mode or the like to be executable. For example, when detailed information such as careers is written on the tag 3A attached to a name card serving as the sheet 3, inputs may be made mainly in the tag write mode so that efficiency would become better in some cases.

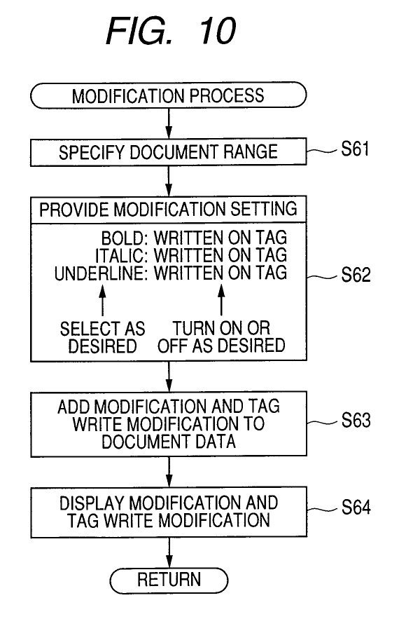

Now, FIG. 10 is a flowchart showing in detail the modification process of S6. In this process, first in S61, a document range is specified as in S51 mentioned above, and then in S62 that follows, a character modification such as bolding, italicizing, or underlining is set for the characters within the range in response to an input on the key board 830 or with the mouse 840. That is, a range of the document data to be character-modified is specified. In S63 and S62, information indicating the tag write modification, i.e., the tag write and printing mode is added to the modified characters. In S64, the results of the character modification and an indication such as the reverse indication representative of the tag write modification (i.e., the tag write and printing mode) are displayed on the characters within the range displayed on the display 820. Then, the process proceeds to S2 mentioned above.

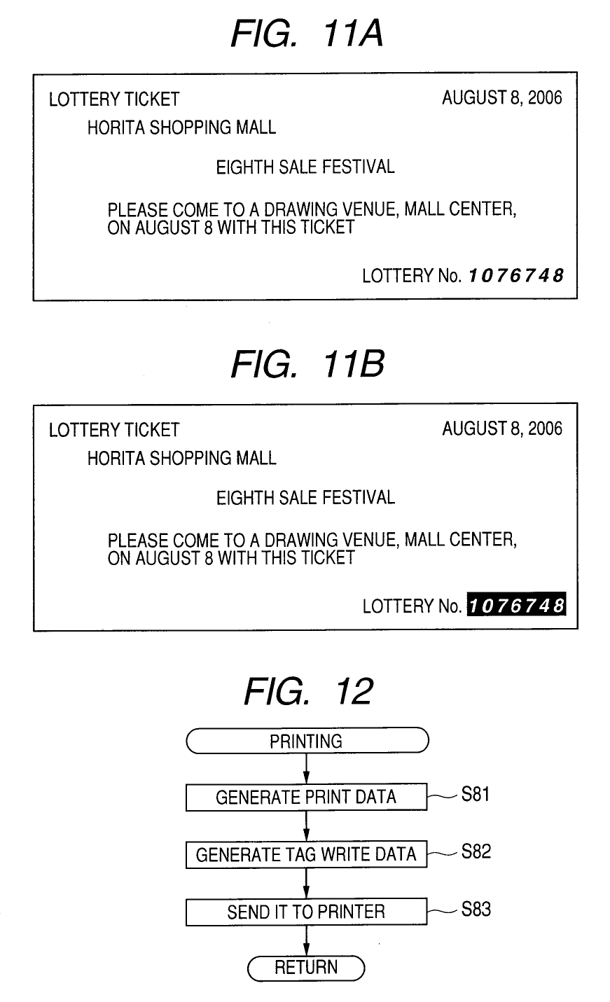

Accordingly, for example, as shown in FIG. 11A as an example, the lottery number of the lottery ticket is provided with an italic bold character modification (S62), and then the lottery number is also set to data to be written onto the tag 3A (S63). Accordingly, as shown in FIG. 11B as an example, the character of lottery number is modified as mentioned above and also reversed or flashed to indicate that it is written onto the tag 3A. In general, a character is often modified to highlight the character because the character shows important information, and thus the character data is often to be written on the tag 3A as well. For this reason, in such a process as above, instructions to enhance the character on the print surface and write it onto the tag 3A can be provided at the same time. Note that as conceptually shown in S62 of FIG. 10, an ON/OFF setting can be set such a tag write modification to any of a number of character modifications such as bolding, italicizing, underlining, coloring of characters and so on.

Now, FIG. 12 is a flowchart showing in detail the printing process of S8. In this process, first in S81, the data inputted in each of the processes to be printed is extracted and rasterized so as to be written into the print data area 813B as print data. In S82, data inputted in each of the processes to be written onto the tag 3A is extracted and then written into the tag write data area 813A as tag write data. In S83, the data written into the tag write data area 813A and the print data area 813B is sent to the printer 1, and then the process proceeds to S2 mentioned above.

[Process in the Control System (Process in the Printer 1)]

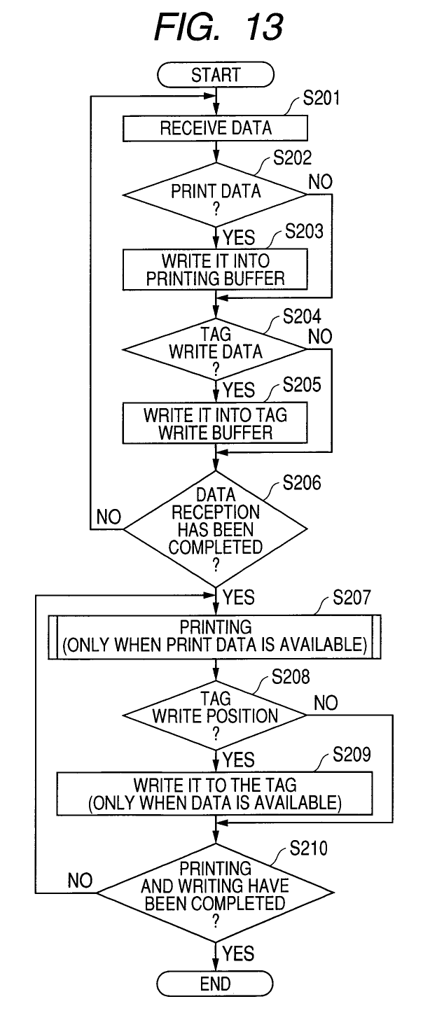

FIG. 13 is a flowchart showing a printer printing process to be executed by the controller 200 of the printer 1 in response to the process of S83. This process is started when the PC 800 sends data to the printer 1.

As shown in FIG. 13, when the process is started, first in S201, the data sent from the PC 800 is received. In S202, it is determined whether the received data is print data. When it is print data (S202: Y), then in S203, the print data is written into a printing buffer defined in the RAM 203. Thereafter, the process proceeds to S204. When it is not print data (S202: N), the process proceeds to S204.

In S204, it is determined whether the received data is tag write data. When it was tag write data (S204: Y), then in S205, the tag write data is written into a tag write buffer defined in the RAM 203. Thereafter, the process proceeds to S206. When it was not tag write data (S204: N), the process proceeds to S206. In S206, it is determined whether the data from the PC 800 has been completely received. If the data has not completely received (S206: N), the process proceeds to S201, so that the processes of S201 to S205 mentioned above will be repeated.

On the other hand, when the data has completely received from the PC 800 (S206: Y), then the process proceeds to S207, where print data, if any, starts to be printed on the sheet 3 by driving the scanner unit 17, the process unit 18 and the like in accordance with the print data. In S208, it is determined whether the sheet 3 has been transported to the tag write position at which the tag writer 38 can write data onto the tag 3A. When it is not at the tag write position (S208: N), the process proceeds to S210. When it is at the tag write position (S208: Y), then in S209, tag write data, only if any, is written onto the tag 3A, and thereafter, the process proceeds to S210.

In S210, it is determined whether printing of data on the sheet 3 and writing of data on the tag 3A has been completed. When not completed yet (S210: N), the process proceeds to S207, so that the processes of S207 to S209 mentioned above will be repeated. When printing onto the sheet 3 and writing onto the tag 3A are completed (S210: Y), then the process ends once. Through the foregoing processes, an image corresponding to the data to be printed is printed on the sheet 3A, while the data to be written onto the tag 3A is written onto the tag 3A.

Furthermore, the controller 200 executes the following tag data read process when it has received from the PC 800 an instruction for reading data on the tag 3A or when the tag read button 220A of the control panel 220 is pressed.

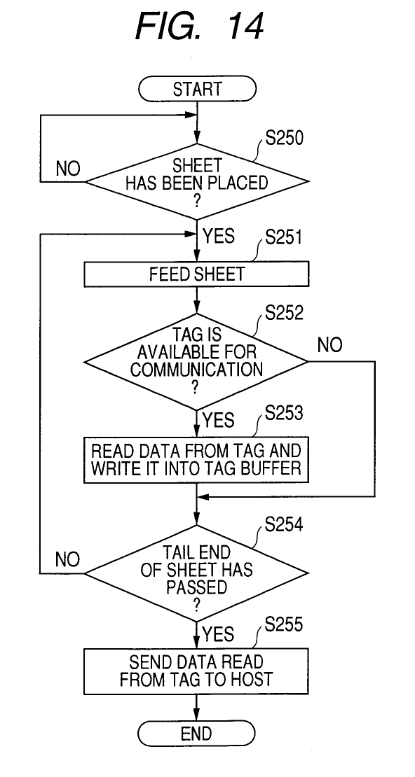

FIG. 14 is a flowchart showing the tag data read process. As shown in FIG. 14, when the process is started, it is first determined in S250 whether the sheet 3 is placed in the multi-purpose tray 14. If the sheet 3 is not placed (S250: N), the process waits as it is in S250. If the sheet 3 is placed (S250: Y), then in S251, the sheet 3 starts to be conveyed.

In S252, it is determined whether the tag reader 16 can communicate with the tag 3A. When the communication is not possible (S252: N), the process proceeds to S254. When the communication is possible (S252: Y), then in S253, data is read from the tag 3A via the tag reader 16 and written into the tag buffer in the RAM 203, and then the process proceeds to S254. In S254, it is determined whether the tail end of the sheet 3 has passed so that the sheet 3 is ejected onto the sheet discharging tray 36. When the tail end of the sheet has not passed (S254: N), the process proceeds to S251 mentioned above, where the processes of S251 to S253 will be repeated. When the tail end of the sheet has passed (S254: Y), the process proceeds to S255.

In S255, the data read from the tag 3A in S253 is sent to the host (in this case, the PC 800), and the process ends. For example, the data in the tag 3A is sent to the PC 800 in this manner, thereby making it possible to check, quickly with ease, the result of drawing for the lottery number.

Note that when data is read from the tag 3A attached to the sheet 3 placed in the multi-purpose tray 14, it is not always necessary to read the data while the sheet 3 is being conveyed. For example, the data may be read by the tag reader 16 from the tag 3A attached to the sheet 3 while being set (placed) in the multi-purpose tray 14.

FIG. 18 shows the tag data read process which enables such a reading operation, with the processes of S251, S252, and S254 shown in FIG. 14 eliminated.

[Effects of the Embodiment]

As described in the foregoing, this embodiment allows for selectively generating or setting efficiently document data only to be printed onto the sheet 3, document data only to be written onto the tag 3A, document data to be printed onto the sheet 3 as well as to be written onto the tag 3A, and those separately inputted data to be printed onto the sheet 3 and to be written onto the tag 3A while being associated with each other. Furthermore, these data are distinguishably displayed on the display 820, thereby making it possible to edit the data with further improved efficiency. In addition, this embodiment allows those data to be printed onto the sheet 3 as well as to be written onto the tag 3A to be set at the same time as the setting of character modifications, thereby making it possible to edit the data with still further improved efficiency.

Note that in the embodiment, the process of S41 in the printing mode or the tag write and printing separate data mode corresponds to the first input mode; the process of S41 in the tag write mode or the tag write and printing separate data mode corresponds to the second input mode; and the process of S41 in the tag write and printing mode corresponds to the third input mode. The process of S43, S54, and S64 corresponds to the display. The process of S51, S52, S61, or S62 for setting the printing mode or the tag write and printing separate data mode corresponds to the first output setting; the process of S51, S52, S61, or S62 for setting the tag write mode or the tag write and printing separate data mode corresponds to the second output setting; and the process of S51, S52, S61, or S62 for setting the tag write and printing mode corresponds to the third output setting. The process of S61 corresponds to the modification range setting unit; and the process of S62 corresponds to the modification setting unit.

Note that although the printing mode, the tag write mode, and the tag write and printing mode can be utilized in the document input and edit process according to the above described embodiment, only at least two of the printing mode, the tag write mode, and the tag write and printing mode may be employed. In addition, although the printing mode, the tag write mode, and the tag write and printing mode can be set in the tag writing and printing modification process according to the above described embodiment, only at least one of the printing mode, the tag write mode, and the tag write and printing mode may be set. In these cases also, it may be possible to edit the data with further improved efficiency.

[Modified Examples of the Embodiment]

The present invention is not limited to the embodiment but may also be implemented in various forms without deviating from the scope and spirit of the present invention. For example, in the printing process of S8, the data generated then in each of the processes (S4 to S6) may be sent as it is to the printer 1.

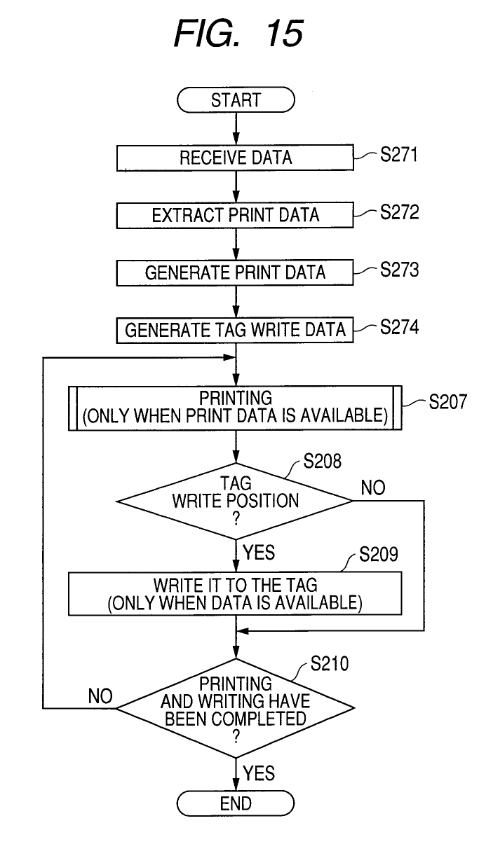

In this case, the printer printing process is changed as follows. FIG. 15 is a flowchart showing the printer printing process in that case. Note that this process is the same as the process of FIG. 13 except that the processes of S201 to S206 mentioned above are changed to the processes of S271 to S274. Description will now be made only for those different points therebetween.

That is, in this process, first in S271, as in S201, the data sent from the PC 800 is received. However, in this case, the received data is not distinguishable as print data and tag write data. In this context, in S272, the data to be printed on the sheet 3 is extracted from the received data, and then in S273, the data is rasterized to generate print data, which is in turn written into the printing buffer. Note that an application may be activated for the rasterization as required.

In S274, the data to be written onto the tag 3A is extracted from the received data as tag write data, which is in turn written into the tag write buffer. After that, the process proceeds to S207 mentioned above. Then, as described above, the extracted and generated print data and tag write data is printed onto the sheet 3 (S207) and written onto the tag 3A (S209). Note that although not illustrated in FIG. 15, when no print data nor tag write data is available, each of the extraction and generation processes will be skipped. In this example, the burden on the PC 800 can be alleviated, thereby preventing other processes on the PC 800 from being adversely affected.

It may be also possible to employ various types of image forming means such as one which forms images by discharging ink, without being limited to the one that forms images by electro-photography as in this embodiment. Furthermore, such a non-contact tag may also be employed which transmits and receives data using infrared rays. Furthermore, when the printer 1 includes a control panel 220 of an appropriate size, all the processes executed by the PC 800 in the embodiment may be executed by the controller 200. In this case, the single printer 1 can form the documentation system of the present invention.

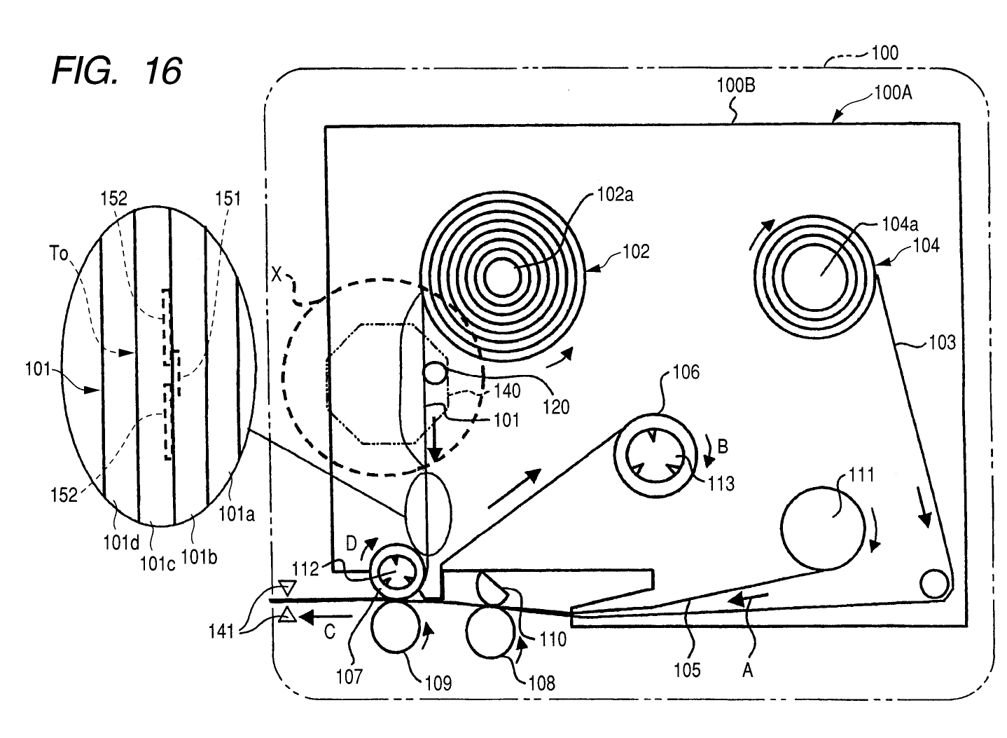

Furthermore, it may be also possible to employ the following label printer as an image forming device. FIG. 16 is an explanatory schematic view showing, by way of example, the configuration of a label printer 100. As shown in FIG. 16, the label printer 100 includes a cartridge 100A. The cartridge 100A includes a housing 100B, a first roll 102 disposed in the housing 100B and having a band-shaped substrate tape 101 wound thereon, a second roll 104 having a transparent cover film 103 wound thereon, the cover film 103 or an example of the recording medium being approximately the same in width as the substrate tape 101, a ribbon feeding roll 111 for dispensing an ink ribbon 105 (or a thermal transfer ribbon, which is not required when the cover film 103 is heat-sensitive tape), a ribbon winding roller 106 for winding the ink ribbon 105 after printing, and a press roller 107 for applying pressure between the substrate tape 101 and the cover film 103 to adhere them together into a printed tag label tape and for feeding the resulting tape in the direction shown by arrow C.

The first roll 102 is configured such that the substrate tape 101 is wound around a reel member 102a and has a plurality of non-contact tags or RFID tags (hereinafter simply referred to as the tags) To formed sequentially at predetermined regular intervals in the longitudinal direction of the tape. In this example, the substrate tape 101 has a four-layer structure (see the enlarged view in the middle portion of FIG. 16). The tape includes an adhesive layer 101a of an appropriate adhesive material, a colored base film 101b of PET (polyethylene terephthalate) or the like, an adhesive layer 101c of an appropriate adhesive material, and a paper peeler 101d. These are stacked in layers in that order in the direction from the inner wound side (the right-hand side in the enlarged view) to the opposite side (the left-hand side in the enlarged view). Then, the tag To includes an antenna portion 152 integrated on the back of the base film 101b (the left-hand side in the enlarged view) and a circuit portion 151 formed to be connected thereto.

Furthermore, the second roll 104 has the cover film 103 wound around a reel member 104a. As discussed later, the ink ribbon 105 dispensed from the ribbon feeding roll 111 is pressed by a head 110 or as an example of the image forming means abutted against the cover film 103 dispensed from the second roll 104, thereby causing the ink ribbon 105 to be brought into contact with the back of the cover film 103.

The ribbon winding roller 106 and the press roller 107 are rotatably driven by the drive force of a motor (not shown) respectively provided outside the cartridge 100A being transmitted to a ribbon winding roller drive shaft 113 and a press roller drive shaft 112. This allows the substrate tape 101 dispensed from the first roll 102 and the cover film 103 dispensed from the second roll 104 to be fed to the press roller 107. Furthermore, the ink ribbon 105 driven by the ribbon feeding roll 111 and the ribbon winding roller 106 is pressed by the head 110 to abut against the back (i.e., the side to be adhered to the substrate tape 101) of the cover film 103 dispensed from the second roll 104.

With the cartridge 100A being placed in the label printer 100, the cover film 103 and the ink ribbon 105 are sandwiched between the head 110 and platen roller 108 while the substrate tape 101 and the cover film 103 are sandwiched between the press roller 107 and a sub-roller 109. Then, the motors cause the ribbon winding roller 106 and the press roller 107 to rotate in the direction shown by arrow B and arrow D, respectively. Furthermore, as the press roller drive shaft 112 is driven, the press roller 107, the sub-roller 109, and a platen roller 108 are rotated via a gear mechanism (not shown). This causes the substrate tape 101 to be dispensed from the first roll 102, so that printing is performed with the head 110 by thermal transfer on the back of the cover film 103.

Then, the substrate tape 101 and the cover film 103 printed as mentioned above are adhered together with the press roller 107 and the sub-roller 109 so as to be formed as a printed tag label tape, which is in turn taken out of the cartridge 100A. Note that the ink ribbon 105 having been used for printing on the cover film 103 is wound around the ribbon winding roller 106 being driven by the ribbon winding roller drive shaft 113.

Furthermore, there is provided a guide roller 120 near where the first roll 102 dispenses. Provided in the vicinity thereof is a tag writer 140 or an example of the data recording means. Note that in FIG. 16, X denotes the coverage of the tag writer 140. As can be seen in the figure, the coverage X extends to the substrate tape 101 wound around the first roll 102. Accordingly, after writing data on the tag To, the tag writer 140 will erase the data which was also written on another tag To, after the tag To has been taken out of the coverage X. Furthermore, the printed tag label tape unreeled from the cartridge 100A by the press roller 107 and the sub-roller 109 is cut off with a cutter 141.

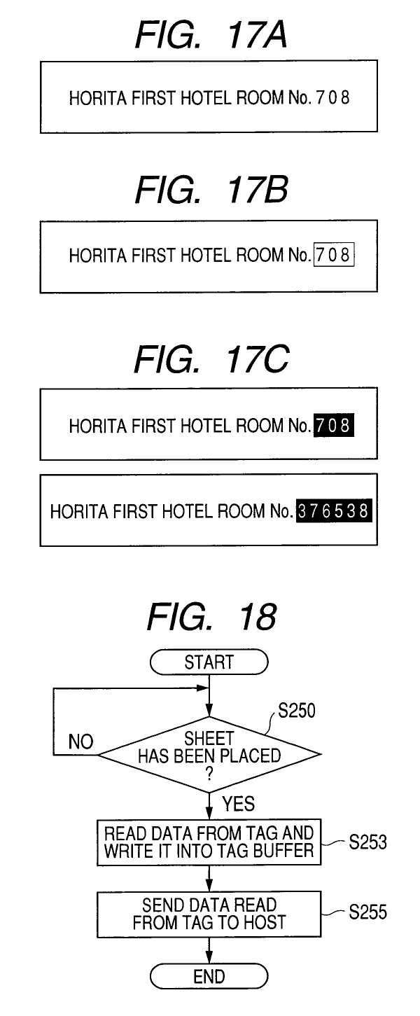

For example, as illustrated by way of example in FIG. 17A, when data to be sent to the label printer 100 configured in this manner is generated, characters can be inputted into a tape-shaped box displayed on the display 820, so that each input mode is available as described above. For example, in the example, a range is specified as shown in FIG. 17B as an example (S51), and the tag write and printing separate data mode is set in that range (S52). In this case, as shown in FIG. 17C as an example, the print document and the tag write document are alternately flashed for display (S54). Furthermore, in this case, when the label printer 100 includes an appropriate key board or display portion, all the processes may also be executed by the controller of the label printer 100.

Furthermore, the tag 3A or To on which data is written as described above may be utilized in various conceivable ways. For example, dates may be written on the tag 3A or To allow a search by date, or numbers or writers of documents may be written on the tag 3A or To. This is made possible by specifying any range in an original document (printed document) and writing the specified range onto the tag, thereby facilitating a search to be made later.

The embodiment is adapted such that in the tag data read process shown in FIG. 14, data is read from the tag 3A attached to the sheet 3 while the sheet 3 held in the multi-purpose tray 14 is being fed. Furthermore, in the tag data read process shown in FIG. 18, data is read by the tag reader 16 from the tag 3A attached to the sheet 3 with the sheet 3 held (placed) in the multi-purpose tray 14. However, methods other than those in this embodiment may also be employed to read (read out) data on the tag.

For example, a tag reader may be provided on the upper surface of a main body case 2 of the printer 1, so that the tag 3A attached to the sheet 3 is held over the tag reader to thereby read (read out) data from the tag 3A. To successively read the data of the tag 3A on a plurality of sheets 3, the sheets 3 may be held one by one over the tag reader for the reading operation. Alternatively, a so-called anti-collision function may be used to sequentially read data from each tag 3A with a plurality of sheets 3 tied in a bundle.

Furthermore, for example, a multi-function device may be equipped with a scanner (original document reader) function, a copier function, or a facsimile function in addition to the printer function. In this case, while the automatic document feeder mechanism (so-called ADF mechanism) included in the scanner function is feeding the sheet 3 attached with the tag 3A, the tag reader installed along the feed path may read the data stored on the tag 3A.

The present invention provides illustrative, non-limiting embodiments as follows:

A document data edit device includes: an input unit that inputs data in input modes including at least two of a first input mode, a second input mode and a third input mode, wherein data inputted in the first input mode is formed as an image on a recording medium, wherein data inputted in the second input mode is recorded as data on a non-contact tag attached to the recording medium, and wherein data inputted in the third input mode is formed as an image on the recording medium and recorded as data on the non-contact tag.

Accordingly, use of the document data edit device according to the above configuration may make it possible to efficiently generate document data to be formed as an image on the recording medium, the document data to be recorded as data on the non-contact tag, and the document data to be formed as an image on the recording medium as well as to be recorded as data on the non-contact tag.

The document data edit device may further include a display that displays the data inputted by the input unit in each of the first to third input modes so as to be distinguishable, respectively. In this case, the indication on the display allows the user to know at a glance which document data was inputted by which input mode, thereby making it possible to edit data with further improved efficiency.

When the data inputted in the first input mode is associated with the data inputted in the second input mode, the display may display the association. In this case, even when the document data to be formed as an image on the recording medium and the document data to be recorded as data on the non-contact tag is totally different from each other, both data can be associated with each other, thereby making it possible to edit data with further improved efficiency.

The data inputted in one of the input modes may be associated with the other data inputted in other one of the input modes.

The document data edit device may further include a display. When the data inputted in one of the input unit modes associated with the other data inputted in the other one of input modes, the display may display the association.

A document data edit device includes: an input unit that inputs data; and a setting unit that specifies a range of the data to be set as at least one of first to third output settings, wherein a range of the data set as the first output setting is formed as an image on a recording medium, wherein a range of the data set as the second output setting is recorded as data on a non-contact tag attached to the recording medium, and wherein a range of the data set as the third output setting is formed as an image on the recording medium and recorded as data on the non-contact tag.

Accordingly, use of the document data edit device of the above configuration may make it possible to efficiently set at least any two of the document data to be formed as an image on the recording medium, the document data to be recorded as data on the non-contact tag, and the document data to be formed as an image on the recording medium as well as to be recorded as data on the non-contact tag.

The document data edit device may further include a display that displays the range of the data set as each of the first to third output settings so as to be distinguishable, respectively. In this case, the indication on the display means allows the user to know at a glance which range of document data was set by which setting means, thereby making it possible to edit data with further improved efficiency.

When the range of the data set as the first setting or the second setting is associated with other data to be recorded on the non-contact tag or other data to be formed as an image on the recording medium, the display may display the association. In this case, even when the document data to be formed as an image on the recording medium and the document data to be recorded as data on the non-contact tag is totally different from each other, both the pieces of data can be associated with each other, thereby making it possible to edit data with further improved efficiency.

The document data edit device may include a modification range setting unit that specifies a range of the data to be character-modified. The range of the data specified to be character-modified by the modification range setting unit may be set as the third output setting. In this case, the range to be formed as an image on the recording medium as well as to be recorded as data on the non-contact tag can be set at the same time a character modification is set, thereby making it possible to edit data with further improved efficiency.

Whether the range of the data specified to be character-modified by the modification range setting unit is set as the third output setting may be selectable. The document data edit device may further include a modification setting unit that sets at least one of a plurality of character-modifications to the range of the data specified by the modification range setting unit. Whether the range of the data set as each of the plurality of character-modifications is set as the third output setting is individually selectable.

In this case, in accordance with an operation of setting the range of a character modification to be made as well as an operation of setting the type of character modification to be made, the data to be written on the non-contact tag can be edited with further improved efficiency.

A documentation system includes a document data edit device and an image forming apparatus. The document data edit device includes: an input unit that inputs data in input modes including at least two of a first input mode, a second input mode and a third input mode; and a display that displays the data inputted by the input unit in each of the first to third input modes so as to be distinguishable, respectively. The image forming apparatus includes: an image forming unit that forms an image on a recording medium in accordance with the data inputted in either one of the first and third input modes; and a data recording unit that records, on a non-contact tag attached to the recording medium, the data inputted in either one of the second and third input modes.

The documentation system of the embodiment according to the present invention configured in this manner makes it possible to form an image on a recording medium, the recording medium being attached with a non-contact tag, in accordance with the document data to be formed as an image on the recording medium and generated or set as described above. By the system, the document data to be recorded as data on the non-contact tag can be recorded on the non-contact tag.

A computer program product embodied on a computer readable medium, which when executed by a computer, causes the computer to perform operations including: inputting data; specifying a range of the data; setting at least one of first to third output settings to the specified range of the data, wherein a range of the data set as the first output setting is formed as an image on a recording medium, wherein a range of the data set as the second output setting is recorded as data on a non-contact tag attached to the recording medium, and wherein a range of the data set as the third output setting is formed as an image on the recording medium and recorded as data on the non-contact tag.

A document data edit device that edits data to be output to first and second output units, includes: an input unit that inputs data in input modes including at least two of a first input mode, a second input mode and a third input mode; first and second storing units; and a controller that (i) stores data inputted in the first input mode to the first storing unit without storing to the second storing unit; (ii) stores data inputted in the second input mode to the second storing unit without storing to the first storing unit; (iii) stores data inputted in the third input mode to the first and second storing units; (iv) outputs data stored in the first storing unit to the first output unit without outputting to the second output unit; and (v) outputs data stored in the second storing unit to the second output unit without outputting the first output unit.

What is claimed is:

1. A document data edit device comprising:
an input unit that inputs data in input modes including at least two of a first input mode, a second input mode and a third input mode,
wherein data inputted in the first input mode is formed as an image on a recording medium,
wherein data inputted in the second input mode is recorded as data on a non-contact tag attached to the recording medium, and
wherein data inputted in the third input mode is formed as an image on the recording medium and recorded as data on the non-contact tag.

2. The document data edit device according to claim 1, further comprising a display that displays the data inputted by the input unit in each of the first to third input modes so as to be distinguishable, respectively.

3. The document data edit device according to claim 2,
wherein when the data inputted in the first input mode is associated with the data inputted in the second input mode, the display displays the association.

4. The document data edit device according to claim 2,
wherein the data inputted in one of the input modes is associated with the other data inputted in other one of the input modes.

5. The document data edit device according to claim 4, further comprising a display,
wherein when the data inputted in one of the input modes is associated with the other data inputted in the other one of the input modes, the display displays the association.

6. A document data edit device comprising:
an input unit that inputs data; and
a setting unit that specifies a range of the data to be set as at least one of first to third output settings,
wherein a range of the data set as the first output setting is formed as an image on a recording medium,
wherein a range of the data set as the second output setting is recorded as data on a non-contact tag attached to the recording medium, and
wherein a range of the data set as the third output setting is formed as an image on the recording medium and recorded as data on the non-contact tag.

7. The document data edit device according to claim 6, further comprising a display that displays the range of the data set as each of the first to third output settings so as to be distinguishable, respectively.

8. The document data edit device according to claim 7,
wherein when the range of the data set as the first setting or the second setting is associated with other data to be recorded on the non-contact tag or other data to be formed as an image on the recording medium, the display displays the association.

9. The document data edit device according to claim 6, further comprising a modification range setting unit that specifies a range of the data to be character-modified,
wherein the range of the data specified to be character-modified by the modification range setting unit is set as the third output setting.

10. The document data edit device according to claim 9,
wherein whether the range of the data specified to be character-modified by the modification range setting unit is set as the third output setting is selectable.

11. The document data edit device according to claim 10, further comprising a modification setting unit that sets at least one of a plurality of character-modifications to the range of the data specified by the modification range setting unit,
wherein whether the range of the data set as each of the plurality of character-modifications is set as the third output setting is individually selectable.

12. A documentation system comprising
a document data edit device including:
an input unit that inputs data in input modes including at least two of a first input mode, a second input mode and a third input mode; and
a display that displays the data inputted by the input unit in each of the first to third input modes so as to be distinguishable, respectively, and
an image forming apparatus including:
an image forming unit that forms an image on a recording medium in accordance with the data inputted in either one of the first and third input modes; and
a data recording unit that records, on a non-contact tag attached to the recording medium, the data inputted in either one of the second and third input modes.

13. A computer program product embodied on a computer readable medium, which when executed by a computer, causes the computer to perform operations comprising:
inputting data;
specifying a range of the data;
setting at least one of first to third output settings to the specified range of the data,
wherein a range of the data set as the first output setting is formed as an image on a recording medium,
wherein a range of the data set as the second output setting is recorded as data on a non-contact tag attached to the recording medium, and
wherein a range of the data set as the third output setting is formed as an image on the recording medium and recorded as data on the non-contact tag.

14. The computer program product according to claim 13,
wherein the operations further comprises: displaying the range of the data set as each of the first to third output settings so as to be distinguishable, respectively.

15. The computer program product according to claim 14,
wherein when the range of the data set as the first setting or the second setting is associated with other data to be recorded on the non-contact tag or other data to be formed as an image on the recording medium, the displaying displays the association.

16. The computer program product according to claim 13,
wherein the operations further comprises specifying a range of the data to be character-modified;
wherein the range of the data specified to be character-modified is set as the third output setting.

17. The computer program product according to claim 16,
wherein whether the range of the data specified to be character-modified is set as the third output setting is selectable.

18. The computer program product according to claim 17,
wherein the operations further comprises setting at least one of a plurality of character-modifications to the range of the data specified to be character-modified,
wherein whether the range of the data set each of the plurality of character-modifications is set as the third output setting is individually selectable.

19. A document data edit device that edits data to be output to first and second output units, comprising:
an input unit that inputs data in input modes including at least two of a first input mode, a second input mode and a third input mode;
first and second storing units; and
a controller that
(i) stores data inputted in the first input mode to the first storing unit without storing to the second storing unit;
(ii) stores data inputted in the second input mode to the second storing unit without storing to the first storing unit;
(iii) stores data inputted in the third input mode to the first and second storing units;
(iv) outputs data stored in the first storing unit to the first output unit without outputting to the second output unit; and
(v) outputs data stored in the second storing unit to the second output unit without outputting the first output unit.

20. The document data edit device according to claim 19,
wherein the first output unit includes an image forming unit that forms an image based on the data outputted from the first storing unit on a recording medium, and
wherein the second output unit includes a data recording unit that records the data outputted from the second storing unit on a non-contact tag attached to the recording medium.
